(19) United States
(12) Patent Application Publication
(10) Pub. No.: US 2008/0294912 A1
(43) Pub. Date: Nov. 27, 2008

(54) SEMICONDUCTOR MEMORY DEVICE

(75) Inventor: Tomoyuki MAEDA, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 11/957,721

(22) Filed: Dec. 17, 2007

(30) Foreign Application Priority Data
Jan. 25, 2007 (JP) 2007-014815

(51) Int. Cl. H04L 9/06

(52) U.S. Cl. 713/193

(57) ABSTRACT

The present invention provides a semiconductor memory device capable of allocating scrambling data different every chip without the need for management and writing of seed data for scramble. If an authentication key inputted from a user to an authentication key register and a decision key set to a decision key register in advance coincide with each other, then read data RD read from a memory chip is outputted as data DT via a selector as it is. If they are found not to coincide with each other, then read data RD (scrambled data SRD) scrambled using, as seed data SD, position information on each defective memory cell, which is outputted from a fuse circuit, is selected by the selector, followed by being outputted as data DT.

### BACKGROUND OF THE INVENTION

The present invention relates to a security technique for preventing information stored in a semiconductor memory device from being falsely read by a third party.

The security of data stored in a semiconductor memory has been of importance in recent years. Scrambling the data stored in the semiconductor memory and outputting the so-scrambled data, for example, is also one method for ensuring the security of the data. It is preferable for this method that the way of scrambling is changed every chip to make it difficult to decode the scrambled data. Further, there has been a demand for possible suppression of an increase in chip size and its implementation at low cost upon execution of scramble processing.

A patent document 1 (Japanese Unexamined Patent Publication No. 2003-115192) has described a semiconductor memory device which compares a read password inputted upon reading and a source password stored in a memory in advance and which outputs data held in a page buffer in a predetermined order if the results coincide and outputs scrambled data in a random-replaced order if the results do not coincide. In the semiconductor memory device, seed data for generating the scrambled data can be set through a dedicated write circuit. Thus, changing the set seed data every chip makes it possible to change the way of scrambling every chip and enhance the confidentiality of data.

The semiconductor memory device described in the patent document 1 needs the process of writing the seed data used for scramble using a testing device and a write device for the purpose of changing the seed data every chip. Therefore, a problem arises in that there is a need to manage the seed data every chip and perform the work for writing the same.

### SUMMARY OF THE INVENTION

The present invention aims to provide a semiconductor memory device capable of allocating scrambling data different every chip without the need for management and writing of seed data for scramble.

According to one aspect of the present invention, for attaining the above object, there is provided a semiconductor memory device which compares an authentication key inputted from a user and a preset decision key and which outputs data stored in a semiconductor memory as it is when they coincide with each other and scrambles the data when they are inconsistent with each other and outputs the so-scrambled data, comprising a scramble circuit for scrambling the data, which is configured so as to use information set to a fuse circuit as seed data for scramble.

In the present invention, for example, information set to the fuse circuit for holding position information on each defective memory cell in the semiconductor memory is used as seed data for scramble. An advantageous effect is brought about in that since the position of each defective memory cell in the semiconductor memory varies depending on each individual semiconductor memory, scrambling data different every chip can be allocated by using the information set to the fuse circuit as the seed data without the need for management and writing of the seed data for scramble.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a configuration diagram of a semiconductor memory device showing a first embodiment of the present invention; and

FIG. 2 is a configuration diagram of a scramble circuit showing a second embodiment of the present invention.

### DETAILED DESCRIPTION OF THE PREFERRED EMBODIMENTS

The above and other objects and novel features of the present invention will become more completely apparent from the following descriptions of preferred embodiments when the same is read with reference to the accompanying drawings. The drawings, however, are for the purpose of illustration only and by no means limitative of the scope of the invention.

### First Preferred Embodiment

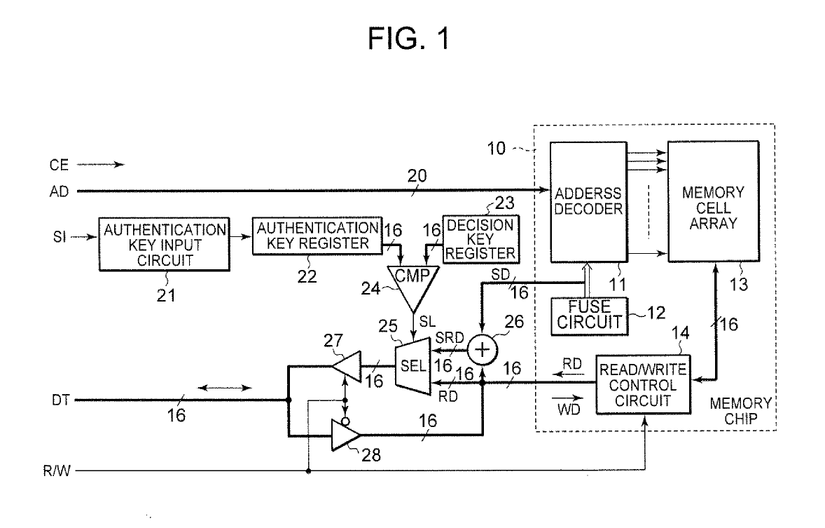

FIG. 1 is a configuration diagram of a semiconductor memory device showing a first embodiment of the present invention.

The semiconductor memory device is connected to, for example, a CPU (Central Processing Unit) and writes data DT into a storage area designated by an address signal AD supplied from the CPU or reads the data DT from the designated storage area. The semiconductor memory device is equipped with a general memory chip 10 for storing data therein.

The memory chip 10 comprises an address decoder 11, a fuse circuit 12, a memory cell array 13 and a read/write control circuit 14. The address decoder 11 decodes the address signal AD to select a storage area in the memory cell array 13. The memory cell array 13 has a plurality of memory cells disposed in matrix form. While the memory cell array 13 performs writing and reading of data DT into and from the corresponding memory cell selected by the address decoder 11, it has redundant memory cells to be used in place of defective memory cells found out or detected upon production inspection.

The fuse circuit 12 comprises fuse groups provided in row and column units of the memory cell array 13. The fuse circuit 12 cut fuses corresponding to rows and columns in which defective memory cells found upon production inspection exist, by, for example, a laser beam or the like, thereby outputting position information on the defective memory cells. The information of the fuse circuit 12 is supplied to the address decoder 11. The address decoder 11 avoids the defective memory cells of the memory cell array 13, based on the address signal AF given from the CPU and the information given from the fuse circuit 12, and selects the normal storage area.

The read/write control circuit 14 performs control on reading and writing of data DT from and into the storage area of the memory array 13 selected by the address decoder 11 in accordance with a read/write control signal R/W supplied from the CPU.

Further, the semiconductor memory device includes, as circuits for ensuring security of the data stored in the memory chip 10, an authentication key input circuit 21, an authentication key register 22, a decision key register 23, a comparator (CMP) 24, a selector (SEL) 25 and a scramble circuit 26.

The authentication key input circuit 21 inputs, for example, a 16-bit authentication key supplied as a serial input signal SI at the early stage where power is turned on to the semiconductor memory device. The authentication key register 22 for holding the input 16-bit authentication key is connected to the output side of the authentication key input circuit 21. The decision key register 23 comprises, for example, a nonvolatile read only memory capable of writing only once and is equivalent to one in which a 16-bit decision key inherent in the semiconductor memory device has been written upon its manufacture.

The comparator 24 compares the authentication key retained in the authentication key register 22 and the decision key written into the decision key register 23. The comparator 24 outputs a selection signal SL of a logic value “1” when they coincide with each other, whereas the comparator 24 outputs a selection signal SL of a logic value “0” when they are found not to coincide with each other. The selection signal SL is supplied as a control signal for the selector 25. The selector 25 selects read data RD corresponding to data DT read from the memory chip 10 when the selection signal SL is “1”, and selects scrambled data SRD outputted from the scramble circuit 26 when the selection signal is “0”.

The scramble circuit 26 uses some of the information outputted from the fuse circuit 12 as 16-bit seed data SD for scramble and scrambles the read data RD outputted from the memory chip 10 in accordance with the seed data SD, thereby generating scrambled data SRD. The scramble circuit 26 comprises, for example, sixteen exclusive OR gates (hereinafter called “EXOR”) and calculates exclusive ORing of the seed data SD and the read data RD every corresponding bit and outputs the result of exclusive ORing as 16-bit scrambled data SRD.

A three-state buffer 27 controlled by the read/write control signal R/W is connected to the output side of the selector 25. When a read operation is designated by the read/write control signal R/W (when, for example, “1” is designated), the read data RD or scrambled data SRD selected by the selector 25 is outputted to the CPU as data DT through the three-state buffer 27.

On the other hand, the data DT given from the CPU is supplied to the read/write control circuit 14 of the memory chip 10 via a three-state buffer 28 controlled by the read/write control signal R/W. When a write operation is designated by the read/write control signal R/W (when, for example, “0” is designated), the three-state buffer 28 outputs the data DT supplied from the CPU to the read/write control circuit 14 as write data WD. Incidentally, the semiconductor memory device performs the operation of writing and reading the data DT only when its operation is permitted by an operation enable signal CE.

The operation of the semiconductor memory device will next be explained.

When power is turned on to the semiconductor memory device and its use is started, a user inputs a 16-bit authentication key as a serial input signal SI via the CPU, for example. The inputted authentication key is received by the authentication key input circuit 21 as a 16-bit authentication key and stored in the authentication key register 22. The authentication key stored in the authentication key register 22 is supplied to one input side of the comparator 24.

A 16-bit decision key inherent in the semiconductor memory device, which has been written into the decision key register 23 upon manufacture, is supplied to the other input side of the comparator 24. Thus, when the inputted authentication key coincides with the pre-written decision key, a selection signal SL outputted from the comparator 24 becomes “1”. If they are found not to coincide with each other, then the selection signal SL reaches “0”.

Since the selection signal SL becomes “1” when a user who knows a proper or correct authentication key, has inputted the proper authentication key, the selector 25 selects read data RD outputted from the memory chip 10.

Next, when a read/write control signal R/W for designating a read operation is supplied from the CPU together with an address signal AD, data DT stored in the storage area designated by the address signal AD is read from the memory cell array 13 and outputted from the read/write control circuit 14 to the selector 25 as read data RD in the memory chip 10. Since the read data RD side is selected in response to the selection signal SL in the selector 25, the read data RD is supplied to the CPU as data DT through the selector 25 and the three-state buffer 27.

On the other hand, when a third party or outsider who does not know the proper authentication key, inputs a random authentication key or does not input it, the selection signal SL outputted from the comparator 24 becomes “0”. Thus, the selector 25 selects scrambled data SRD outputted from the scramble circuit 26.

Next, when a read/write control signal R/W for designating a read operation is supplied from the CPU together with an address signal AD, data DT stored in the corresponding storage area designated by the address signal AD is read from the memory cell array 13 and outputted from the read/write control circuit 14 to the scramble circuit 26 as read data RD in the memory chip 10. The scramble circuit 26 scrambles the read data DT in response to seed data SD corresponding to part of information outputted from the fuse circuit 12 and generates scrambled data SRD, followed by supply to the selector 25.

Since the scrambled data SRD side is selected in accordance with the selection signal SL in the selector 25, the scrambled data SRD is supplied to the CPU as data DT through the selector 25 and the three-state buffer 27. Accordingly, the data DT supplied to the CPU is different from the normal read data RD.

Incidentally, when the data DT given from the CPU is written in the semiconductor memory device, the data DT is supplied via the three-state buffer 28 to the read/write control circuit 14 of the memory chip 10 as write data WD and written into the memory cell array 13.

As described above, the semiconductor memory device according to the first embodiment brings about the following advantages.

(1) Since the seed data SD is obtained from the fuse circuit 12 contained in the general memory chip 10, scrambling data different every chip can be allocated without the need for management and writing of the scrambling seed data.

(2) Since the seed data SD is obtained from the fuse circuit 12 contained in the general memory chip 10, an additional circuit for generating the scrambling data becomes unnecessary and an increase in chip area can hence be suppressed.

(3) Since some of the information of the fuse circuit 12, which is indicative of the position of each defective memory cell, is scrambled as the seed data SD, scrambled data SRD different every memory chip are produced even though the read data RD are identical to each other. Thus, decoding becomes more difficult, and there is no fear that even though data of one semiconductor memory device is decoded, data of another semiconductor memory device is decoded immediately.

(4) Since the scrambled data DT is outputted according to the read operation even the authentication key is not inputted or an incorrect authentication key is inputted, the third party who will read data falsely is hard to determine whether it is the normal data.

### Second Preferred Embodiment

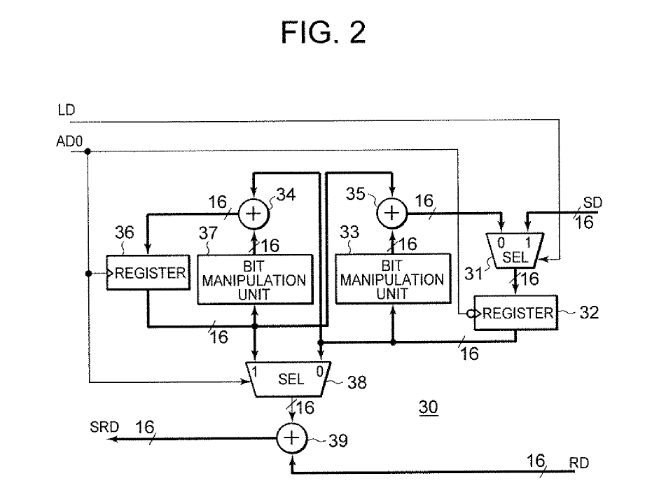

FIG. 2 is a circuit diagram of a scramble circuit showing a second embodiment of the present invention.

The scramble circuit 30 is provided in place of the scramble circuit 26 shown in FIG. 1 and is equivalent to one which makes decoding difficult by making the way of scrambling more complicated.

The scramble circuit 30 has a selector 31 which has a first terminal supplied with 16-bit seed data SD from a fuse circuit 12 and selects the seed data SD in response to a load signal LD upon initial setting. A 16-bit register 32 is connected to the output side of the selector 31.

The register 32 holds input data at the timing of fall of an address signal AD0 of the least significant bit and outputs the same therefrom. The output side of the register 32 is connected to the first input sides of a bit manipulation unit 33 and an EXOR 34. The bit manipulation unit 33 rearranges 16-bit data given from the register 32. The output side of the bit manipulation unit 33 is connected to the first input side of an EXOR 35. The output side of the EXOR 35 is connected to a second input terminal of the selector 31.

On the other hand, the output side of the EXOR 34 is connected to a register 36. The register 36 holds input data at the timing of rise of the address signal AD0 and outputs the same therefrom. The output side of the register 36 is connected to the second input side of a bit manipulation unit 37 and the second input side of the EXOR 35. The bit manipulation unit 37 rearranges 16-bit data given from the register 36. The output side of the bit manipulation unit 37 is connected to the second input side of the EXOR 34. Incidentally, the bit manipulation unit 37 and the bit manipulation unit 33 may be identical in the way of rearranging the data. However, a more complicated scramble can be performed by changing how to rearrange the data.

Further, the scramble circuit 30 has a selector 38 which outputs the data of the registers 32 and 36 by switching according to the value of the address signal AD0. The output side of the selector 38 is connected to the first input side of an EXOR 39. The second input side of the EXOR 39 is supplied with read data RD given from the memory chip 10. Scrambled data SRD scrambled by the data outputted from the selector 38 is outputted from the EXOR 39.

In the scramble circuit 30, the selector 31 is switched to the seed data SD side in response to the load signal DL upon its initial setting, so that the seed data SD is set to the register 32. On the other hand, the value of the register 36 becomes an undefined value by power-on. Thereafter, the selector 31 is switched to the EXOR 35 side, so that the register 32 is supplied with the result of arithmetic operation by the EXOR 35.

When the read operation is started and the address signal AD0 changes, the result of arithmetic operation by the EXOR 34 is retained in the register 36 at the timing of rise from “0” to “1”, and the result of arithmetic operation by the EXOR 35 is retained in the register 32 at the timing of fall from “1” to “0”. The contents of the register 36 are supplied to the EXOR 35, and the bit manipulation unit 37 rearranges bits and supplies the result of rearrangement thereof to the EXOR 34. Further, the contents of the register 32 are supplied to the EXOR 34, and the bit manipulation unit 33 rearranges bits and supplies the result of rearrangement thereof to the EXOR 35.

In addition, the contents of the registers 32 and 36 are respectively given to the selector 38 controlled based on the address signal AD0. When the address signal AD0 is “0”, the contents of the register 32 are selected. When the address signal AD0 is “1”, the contents of the register 36 are selected and outputted. The output of the selector 38 is supplied to the EXOR 39, where the read data RD is scrambled to generate the corresponding scrambled data SRD.

As described above, the scramble circuit 30 according to the second embodiment has the register 32 which holds the seed data SD outputted from the fuse circuit 12 as the initial value, the register 36 which holds the undefined value at power-on as the initial value, the bit manipulation units 33 and 37 which rearrange the positions of the bits of these registers 32 and 36 respectively, and the EXORs 34 and 35 which calculate exclusive ORing of the values rearranged by the bit manipulation units 33 and 37 and the values of the registers 36 and 32. The results of arithmetic operations by the EXORs 34 and 35 are respectively retained in the registers 36 and 32 at the timings of rise and fall of the address signal AD0. Further, the scramble circuit 30 has the selector 38 which selects the contents of the registers 32 and 36 in accordance with the address signal AD0 and outputs the data for scramble, and the EXOR 39 which scrambles the read data RD in accordance with the scrambling data outputted from the selector 38.

Thus, the generation of the scrambled data becomes more complicated. An advantage is brought about in that since the data held in the registers 32 and 36 are updated by reference to the mutual registers, the random scrambled data SRD can be outputted even where the same values are continuous for the read data RD. Further, an advantage is brought about in that since the address signal AD0 is used for the update timings of the registers 32 and 36, the present invention can be applied even to a semiconductor memory device free of a clock dedicated terminal.

Incidentally, the present invention is not limited to the above embodiments. Various modifications can be made thereto. As examples of the modifications, for example, the following are brought about.

(a) Although the numbers of bits for the authentication key and the decision key are respectively set to 16 bits, the sizes thereof are arbitrary. Although the bit width of the data DT is set to 16 bits in like manner, the bit width is also optional. Further, the size of the address signal AD is also optional. The method of inputting the authentication key is arbitrary.

(b) Although the decision key register 23 has been described as the read-only memory different from the memory chip 10, it can also be configured in such a manner as to read nonvolatile data stored in a specific area of the memory chip 10 at power-on and hold the same.

(c) Although the fuse circuit 12 makes use of one which stores therein the position information on each defective memory cell, one which stores other set information therein can also be utilized.

(d) Although the least significant bit (AD0) of the address signal AD has been used as the clock signal for the registers 32 and 36, the bit position is not limited to it.

(e) The circuit configurations of the scramble circuits 26 and 30 are not limited to the illustrated ones.

What is claimed is:

1. A semiconductor memory device which compares an authentication key inputted from a user and a preset decision key and which outputs data stored in a semiconductor memory as it is when they coincide with each other and scrambles the data when they are inconsistent with each other and outputs the so-scrambled data, said semiconductor memory device comprising:
a scramble circuit for scrambling the data, which is configured so as to use information set to a fuse circuit as seed data for scramble.

2. The semiconductor memory device according to claim 1, wherein the fuse circuit holds information about a position of each defective memory cell in the semiconductor memory.

3. The semiconductor memory device according to claim 1 or 2, wherein the scramble circuit calculates exclusive ORing of the data stored in the semiconductor memory and the seed data every bit and outputs a result of exclusive ORing therefrom.

4. The semiconductor memory device according to claim 1 or 2, wherein the scramble circuit includes:
a first register which sets the seed data as an initial value,
a second register which sets an undefined value at power-on as an initial value,
a first bit manipulation unit which rearranges the order of bits of data outputted from the first register,
a second bit manipulation unit which rearranges the order of bits of data outputted from the second register,
a first exclusive OR gate which exclusive-ORs the data outputted from the first bit manipulation unit and the data outputted from the second register every bit and outputs a result of exclusive ORing therefrom,
a second exclusive OR gate which exclusive-ORs the data outputted from the second bit manipulation unit and the data outputted from the first register every bit and outputs a result of exclusive ORing therefrom,
a selector which switches the data outputted from the first or second register in accordance with an address signal, and
a third exclusive OR gate which exclusive-ORs the data outputted from the selector and the data read from the semiconductor memory every bit,
wherein the output of the first exclusive OR gate is fetched into the first register at a timing of fall of the address signal, and the output of the second exclusive OR gate is fetched into the second register at a timing of rise of address signal.
